(19) United States
(12) Patent Application Publication
(10) Pub. No.: US 2007/0005711 A1
(43) Pub. Date: Jan. 4, 2007

(54) System and method for building instant messaging applications

(75) Inventors: Khaled Hassounah, Charlestown, MA (US); Eric Yoo, Somerville, MA (US); Ajay Varia, Waltham, MA (US)

Correspondence Address: WILMER CUTLER PICKERING HALE AND DORR LLP, 1875 PENNSYLVANIA AVE., NW, WASHINGTON, DC, 20004, US

(73) Assignee: IMIogic, Inc., Waltham, MA (US)

(21) Appl. No.: 11/171,642

(22) Filed: Jul. 1, 2005

(51) Int. Cl. G06F 15/16

(52) U.S. Cl. 709/206

(57) ABSTRACT

Systems, methods and mediums for receiving an instant messaging message transmitted by a first client, deconstructing the message, and reconstructing the message for transmission to a second client.

### BACKGROUND OF THE INVENTION

1. Field of the Invention

The present invention relates generally to systems and methods for building instant messaging applications and, more particularly, to systems and methods that provide a common application framework that can be utilized in connection with various instant messaging systems.

2. Background Description

Instant messaging (IM) systems, such America Online Corporation (AOL) Instant Messenger (AIM), MSN, and Yahoo! Messenger, were initially designed primarily for the consumer space, where ease of use and minimal configuration are primary objectives. Each of the various IM systems utilize their own proprietary protocols, thereby making building applications that may encompass two or more IM systems difficult and unwieldy. For example, in order to build a system that will identify and extract messages transmitted by users of AIM and MSN, a software designer will need to account for various proprietary aspects of the AIM and MSN systems in order to extract the messages from each IM system.

We have discovered that heretofore-unaddressed needs exist for systems and methods that can receive IM message traffic from one or more IM systems and provide a standard manner in which information associated with IM message traffic and/or one or more characteristics associated with various messages associated with the various IM systems can be extracted.

### SUMMARY OF THE INVENTION

The present invention provides systems and methods that can receive IM message traffic from one or more IM systems and provide a standard manner in which information associated with IM message traffic and/or one or more characteristics associated with various messages associated with the various IM systems can be extracted. Advantageously, embodiments of the present invention facilitate the ability to build applications utilizing the information and characteristics. For example, embodiments of the present invention facilitate the building of login and logout operations, messaging operations, subscription operations, notification operations, status change operations, and file transfer operations.

In one embodiment of the present invention, a computer program product residing on a computer readable medium, for use in a computer network environment that utilizes one or more instant messaging (IM) protocols, includes instructions for causing a computer to: i) receive a message transmitted by a first client; ii) deconstruct the message by identifying the message by a type of operation, identifying at least one attribute associated with the message, and filtering the message based upon the at least one attribute; and iii) reconstruct the message for transmission to a second client.

The message can be deconstructed into one or more dispatch units. Filtering instructions can block dispatch units, redirect dispatch units, pass dispatch units, or inject a new dispatch unit. Dispatch units transmitted to the filtering instructions can be associated with one or more IM protocols. A data construct can be used in connection with each of the dispatch units that is transparent to the filtering instructions.

The deconstruct and reconstruct instructions can be transparent to the second client. In addition, one or more embodiments of the present invention can also include instructions that facilitate access to data pertaining to the type of operation and/or to at least one attribute.

The type of operation can include login, logout, transmitted message, received message, subscription, notification, status change, privacy list, default privacy setting, and file transfer operations. A login operation can include at least one of a login request and a login response, and the logout operation can include at least one of a logoff request and a logoff response.

A transmitted message operation can include at least one of an invite request, invite response, join request, join response, message request, message response, leave request, and leave response operations. In addition, subscription, notification, and status change operations can include a request and a response.

A privacy list operation can include at least one of an allow user request and response, a block user request and response, a default privacy setting request and response, and an allow list request and response. A file transfer operation can include at least one of i) a begin file transfer request and response, ii) a file transfer request and response, iii) a cancel file transfer request and response, iv) a source protocol, v) a destination protocol and vi) a property bag that includes one or more of items i), ii), iii), iv) and v).

Attributes can include at least one of family, type, context, source end point, destination end point, and direction. IM protocols that can be utilized in conjunction with the present invention include AOL Instant Messenger (AIM), Yahoo Messenger, MSN, the Extensible Messaging and Presence Protocol (XMPP), the International Telecommunication Union (ITU) H.323 standard, Yahoo Messenger, and the Session Initiation Protocol (SIP).

In another embodiment of the present invention, a method for use in a computer network environment that utilizes one or more instant messaging (IM) protocols includes receiving a message transmitted by a first client; deconstructing the message by i) identifying the message by a type of operation and a context, ii) identifying at least one attribute associated with the message; and iii) filtering the message based upon the at least one attribute; and reconstructing the message for transmission to a second client.

The context can include a login context, a conversation context and a file transfer context. In addition, the type of operation can include one of a login, a logout, a transmitted message, a received message, a subscription, a notification, a status change, a privacy list, a default privacy setting, and a file transfer. The method can also include facilitating access to data pertaining to the type of operation.

Before explaining at least some embodiments of the invention in detail, it is to be understood that the invention is not limited in its application to the details of construction and to the arrangements of the components set forth in the following description or illustrated in the drawings. The invention is capable of other embodiments and of being practiced and carried out in various ways.

### BRIEF DESCRIPTION OF THE DRAWINGS

The Detailed Description including the description of a preferred structure as embodying features of the invention will be best understood when read in reference to the accompanying figures wherein:

FIG. 1 is a block diagram of an exemplary system and architecture that can be used in connection with one or more embodiments of the present invention.

FIG. 2 is a block diagram of an architecture of an embodiment of the present invention.

FIG. 3 is a diagram of a process flow in accordance with an embodiment of login and logout operations of the present invention, which also illustrates an overview of a method according to the present invention.

FIG. 4 is a diagram of a process flow in accordance with an embodiment of messaging operations of the present invention, which also illustrates an overview of a method according to the present invention.

FIG. 5 is a diagram of a process flow in accordance with an embodiment of subscription, notification and status change operations of the present invention, which also illustrates an overview of a method according to the present invention.

FIG. 6 is a diagram of a process flow in accordance with an embodiment of file transfer operations of the present invention, which also illustrates an overview of a method according to the present invention.

### DETAILED DESCRIPTION OF AN EMBODIMENT OF THE INVENTION

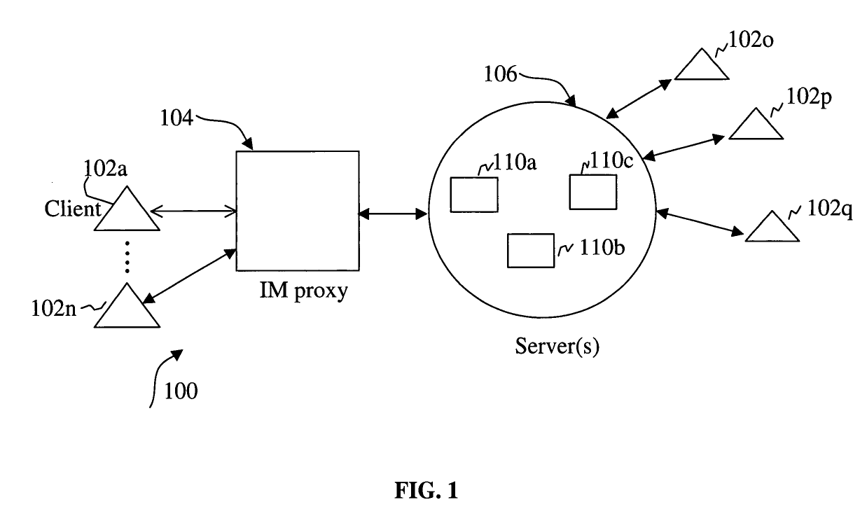

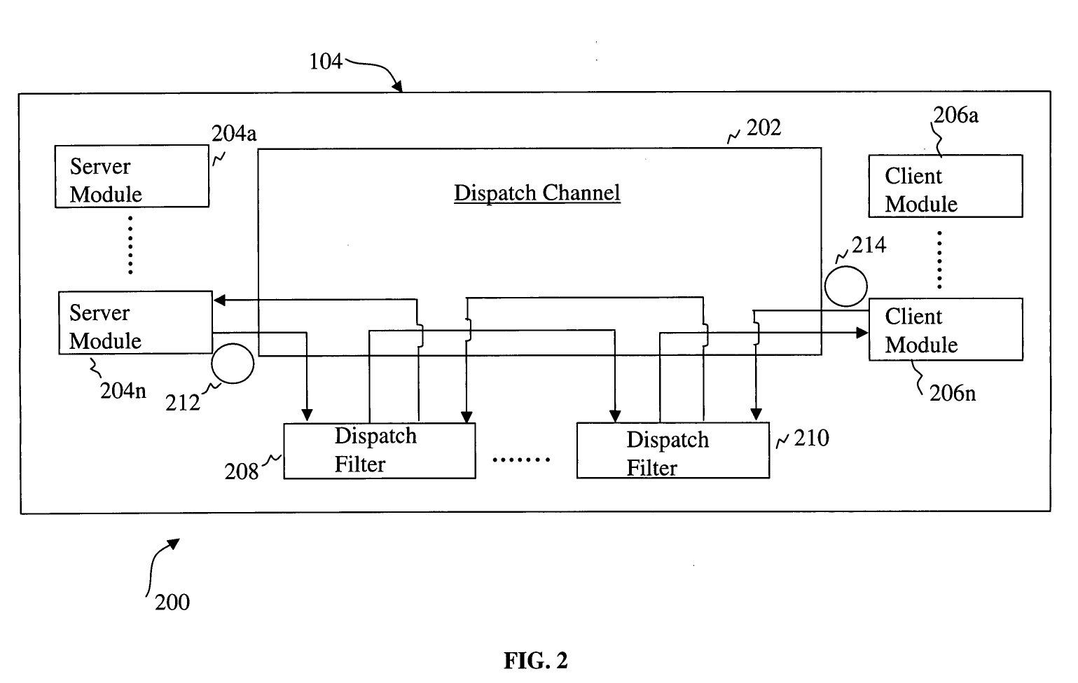

FIG. 1, generally at 100, is a block diagram of an exemplary system and architecture of an embodiment of the present invention. System 100, which in the embodiment shown in FIG. 1 consists of clients 102a-q which may be running, for example, on a standard desktop computer, laptop computer, and/or personal digital assistant (PDA). Clients 102a-n may utilize either a wired or wireless connection to transmit and receive data. System 100 also includes proxy server 104, and network 106. System 200, as generally described in connection with FIG. 2, can run on or be implemented in connection with proxy server 104.

Clients 102a-q can be applications that run, for example, on a standard personal computer and utilize a standard server 110a-c to perform some operations. In client-server architecture, client 102a-q software handles sending and receiving for clients 102a-n, while server 110a-c software handles sending and receiving for network 106. Servers 110a-c are computers or software applications that are generally accessed by other computers and/or clients 102a-q. Servers 110a-c can provide a specific kind of service to client 102a-q software running on other computers.

Proxy server 104 is positioned physically and/or logically between clients 102a-n and servers 110a-c. Clients 102a-n, as well as clients 102o-q, can be configured to use proxy server 104 as an instant messaging (IM) server. For example, client 102a can make requests to proxy server 104. In turn, proxy server 104 can make a request to one or more of servers 110a-c, and pass the result(s) back to client 102a.

Network 106 can consist of the Public Switched Telephone Network (PSTN), the Internet and/or a wireless network. Other network infrastructure can also be utilized. For example, system 100 may also include a long distance network (LDN) operatively connected to the PSTN, and a terminating local PSTN operatively connected to the LDN.

FIG. 2, generally at 200, shows a diagram of an exemplary system and architecture of an embodiment of the present invention. System 200 can reside on, or be implemented on, proxy server 104. System 200 can include dispatch channel 202, server modules 204a-n, client modules 206a-n, and dispatch filters 208, 210. As used herein, a module generally refers to software code. There can be any number of server modules 204a-n, dispatch filters 208, 210, and client modules 206a-n.

In general, server module 204a-n and client module 206a-n encapsulate the implementation of various instant messaging protocols (e.g., AIM, MSN, etc.) as well as provide basic instant messaging services. In addition, server module 204a-n and client module 206a-n include and provide a common language of instant messaging operations upon which end user Application Programming Interfaces (APIs) can be developed.

Server module 204a-n and client module 206a-n can include IM protocols or features that are used by standard IM systems (e.g., AIM, MSN, etc.). For example, if server module 204a and client module 206a include or provide chat session manager functionality, they can manage chat sessions and provide an abstraction for chat sessions that can be used by one or more applications. For example, one application might be to log all IM traffic into a database or data repository (not shown), for various IM Protocols used (e.g., AIM, MSN, Extensible Messaging and Presence Protocol (XMPP), the International Telecommunication Union (ITU) H.323 standard, Yahoo Messenger and/or the Session Initiation Protocol (SIP)). In addition, server module 204a-n and client module 206a-n can include the packet defined for the IM family. For example, “inbound” can be utilized to indicate that a dispatch unit is being transmitted to client 102a-n, whereas “outbound” can be utilized to indicate that a dispatch unit is being transmitted from client 102a-n. Inbound and outbound can also optionally be defined with respect to proxy server 104.

As previously noted, any number of dispatch filters 208, 210 can be utilized. In addition, two or more server modules 204a-n and two or more client modules 206a-n can be utilized, for example, in connection with two or more IM protocols. For example, server module 204a and client module 206a can be used in connection with AIM, and sever module 204b and client module 206b can be used in connection with MSN. However, a single server module 204 and a single client module 206a may also be utilized to receive, process and transmit two or more IM protocols.

Dispatch channel 202 provides the transport layer that facilitates communication between server module 204a-n and client module 206a-n. Clients 102a-n can use system 200 to transmit data, for example, to clients 102o-p. Server module 204a-n can generate request dispatch units 212, and client module 206a-n can generate response dispatch units 214. It should be understood that the position of server module 204a-n and client module 206a-n can be reversed. In general, a message that is first transmitted by a client 102a-n will be received by server module 204a-n. When another client (e.g., client 102q) receives the message, client 102q will transmit a message that is first received by client module 206a-n, and subsequently transmitted to client 102a-n via server module 204a-n. Dispatch units 212, 214 provide the abstraction for various IM protocols. Dispatch units can represent, for example, an event, a command, a message and/or a network packet, depending on its family, type and content, as will be described herein.

When client 102a-n transmits a message to proxy server 104 the message is received by server module 204a-n, which creates one or more request dispatch units 212 from the message. When server module 204a-n generates a request dispatch unit 212, client module 206a-n will generate a response dispatch unit 214, generally asynchronously. A response dispatch unit 214 can contain, for example, a status code indicating that the response dispatch unit 214 has successfully received and responded to a request dispatch unit 212 or that the response dispatch unit 214 has not successfully responded to the received dispatch unit 212. Response dispatch unit 214 may also contain data properties that did not exist in the request dispatch unit 212 such as, for example, a default privacy setting. Response dispatch units 214 are generally generated and returned when a request dispatch unit 212 is completed. For example, a response dispatch unit 214 for a Login dispatch unit 212 is returned when a client 102a has completed the login process.

Dispatch units 212, 214 have a set of attributes that aid the dispatch units 212, 214 in identifying one or more filters 208, 212 that the dispatch unit will utilize as they are respectively transmitted from server module 204a-n to client module 206a-n, and returned from client module 206a-n to server module 204a-n.

Attributes can include family, type, context, source end point, destination end point, direction, and a property bag whose content depends, for example, on the value of a combination of a variety of those attributes. The family and type attributes, for example, can receive additional weighting. Exemplary families can include: i) login and logout; ii) messaging; iii) subscriptions, notifications and status changes; iv) privacy lists and default privacy settings; and v) file transfer. Within the login and logout family, there can be, for example, login and logout types of dispatch units. Within the messaging family, there can be, for example, invite, join, messaging, and leave types of dispatch units. Within the subscriptions, notifications and status changes family there can be, for example, subscription, unsubscription, notification, and status change types of dispatch units. Within the privacy lists and default privacy settings family, there can be, for example, allow user, block user, set default privacy setting, get privacy default setting, get allow list, and get block list types of dispatch units. Finally, within the file transfer family, there can be, for example, begin file transfer, transfer file, and cancel transfer file types of dispatch units.

Source end point can be, for example, server module 204a-n or client module 206a-n. Similarly, destination end point can be, for example, server module 204a-n or client module 206a-n. Direction can be outbound (e.g., transmitted from client 102a-n), or inbound (e.g., transmitted to client 102a-n).

A login context can include a login dispatch unit, a logout dispatch unit, a subscribe dispatch unit, an unsubscribe dispatch unit, a subscription notification dispatch unit, an unsubscription notification dispatch unit, a status notification dispatch unit, a status change dispatch unit, a contact list dispatch unit, an allow user dispatch unit, a block user dispatch unit, and a set default privacy dispatch unit.

A login dispatch unit can be generated when client 102a-n attempts to establish a session, and can include events generated by and information published by client 102a-n on behalf of a particular user account and the events generated for and information published to client 1002a-n on behalf of a particular user. A logout dispatch unit indicates the termination of a session, and may be initiated by either client 102a-q or proxy server 104.

A subscribe dispatch unit indicates that a first client (e.g., client 102a) is requesting notifications of another client's (e.g., client 102q) presence. A dispatch unit that is generated in response to a subscribe dispatch unit can indicate that a server 110a-c has accepted the subscription. An unsubscribe dispatch indicates that client 102a-n does not want to receive notifications of another client's (e.g., client 102q) presence. A dispatch unit that is generated in response to an unsubscribe dispatch unit can indicate that a server 110a-c has accepted the unsubscription.

A subscription notification dispatch unit indicates that a client (e.g., client 102q) user has subscribed to another client (e.g., 102a). An unsubscription notification dispatch unit indicates that a client (e.g., client 102q) user has unsubscribed from another client (e.g., 102a).

A status notification dispatch unit indicates that server 110a-c has published a client's status 102a-n to a subscribed client 102q. A status change dispatch unit indicates that server 110a-c is notifying a subscribed client 102a-n about the status of a target client 102q.

A contact list dispatch contains the server 110a-c copy of the contact list of the client's (e.g., clients 102a-n) subscribed to. An allow user dispatch unit indicates that a client (e.g. 102a) is allowing another client (e.g. client 102b) to view its presence. A block user dispatch indicates that a client (e.g., client 102a) is blocking another client (e.g., client 102b) from seeing its presence. A set default privacy dispatch unit sets the default privacy policy for clients (e.g., clients 102a-c) for whom a block/allow has not been specifically issued.

A conversation context has dispatch units associated with a single conversation. Typically, clients 102a-q display such relevant events in a standard user interface window to maintain continuity. Dispatch units associated with a conversation context can also be associated with its parent login context. The generation and processing of conversation lifetime dispatches (e.g., invite, join, leave) without corresponding real network events can be collectively referred to as “virtual conversations,” which allow consistent processing with two-party and multiparty (“chat”) conversations.

An invite dispatch unit allows a client (e.g., client 102a) to request (or invite) another client (e.g., client 102b) to join the conversation. A join dispatch unit allows one or more clients (e.g., clients 102a-c) to join a conversation, and thus allow the clients 102a-c to receive messages transmitted to the conversation and be able to transmit messages to the conversation. A leave dispatch unit allows one or more clients (e.g. clients 102a-c) to leave the conversation. Such clients 102a-c thus no longer be able to receive messages from or transmit messages to the conversation.

In a file transfer context, dispatch units encompass or relate to the transfer of one or more files from a first client (e.g., client 102a) to a second client (e.g., client 102q). A file transfer context can have a parent login context or a parent conversation context. A begin file transfer dispatch unit enables a client 102a to offer a file for transfer to another client 102n. A dispatch unit responding to the begin file transfer dispatch unit can indicate that client 102n has accepted the transfer. A file transfer dispatch unit indicates that a file is being transferred. A dispatch unit responding to a file transfer dispatch unit can indicate that client 102n has received the complete file. A cancel file transfer dispatch unit indicates that a file transfer has been canceled by one or more of participating clients 102a, 102n. A cancel file dispatch unit will be transmitted after the begin file transfer dispatch unit and before a dispatch unit responding to a file transfer dispatch unit issues.

Dispatch units 212 begin as a request dispatch units, and are delivered to client module 206a-n. In turn, client module 206a-n can reply with a response dispatch unit 214, which can be the same as dispatch unit 212, but also possibly include additional information depending, for example, on the family and type of the request dispatch unit 212.

When a dispatch unit 212 is submitted to dispatch channel 202, dispatch channel 202 will pass dispatch unit 202 through one or more filters 208, 212 before it is delivered to one of client module 206a-n. When filters 208, 210 are registered with dispatch unit 212, dispatch unit 212 receives information that it may utilize to determine which filters 208, 210 it will utilize, and the order in which any such filters 208, 210 will be utilized. Filters 208, 210 can access the content of dispatch unit 212, and have the ability to pass, block and modify dispatch units 212.

Dispatch units originate as a request dispatch unit 212, and pass through one or more filters 208, 212, prior to being received at client module 206a-n. After any communication with and/or processing of an IM message by, for example, a second client (e.g., client 102q), client module 206 responds with a response dispatch unit 214 for each dispatch unit 212 request that it receives. A response dispatch unit 214 provides, for example, a mechanism for error reporting for the call that was made to deliver the request packet.

Filters 208, 210 can read, modify, create, and consume request dispatch units 212 as they are transmitted between server module 204a-n and client module 206a-n. Response dispatch units 214 will generally pass through the same filters as request dispatch units 212, but in reverse order (from client module 206a-n to server module 204a-n).

For example, if filter 208 is a message logging filter, filter 208 may receive and filter request dispatch units 212 by the type of message that dispatch 208 represents. For example, as noted above, in accordance with an embodiment of the invention, dispatch units can include the following families: i) login and logout; ii) messaging; iii) subscriptions, notifications and status changes; iv) privacy lists and default privacy settings; and v) file transfer. Thus, if dispatch unit 212 is from the messaging family, and filter 208 is designated to receive messages from the messaging family, dispatch unit 212 will pass through filter 208. Dispatch units that are not from the messaging family will not pass through filter 208 unless filter 208 is designated to also receive dispatch units 212 from one or more other families or types (e.g., the login and logout family and/or the file transfer family).

By way of example, messaging filter can have, for example, a logging function (or application) in which the filter can read the message content from the dispatch unit 212, log the content to a repository such as a database (not shown), and transmit dispatch unit 212 to another filter (e.g., filter 210) or to client module 206a-n.

As another example, suppose filter 210 is an access filter. An access filter can be utilized, for example, to implement client login control. An access filter filters dispatch units 212 by whether a user is logging in or logging out. When an access filter receives a dispatch unit 212 that is requesting a login, the filter reads from the dispatch unit 212 the username of the user (client) logging in and the target network, and blocks dispatch unit 212 if the user is not allowed by security policy to use the target network.

There are several different types of filters 208, 210 for different use cases. Filters 208, 210 are registered with dispatch channel 202 with a set of filter criteria, which determine which dispatch units 212 are filtered. For example, a filter that is interested in receiving a dispatch unit 212 that contains a message for a particular network and/or protocol, can register to receive a dispatch unit that includes those particular criteria. Filters can also be registered with a priority (relative to other filter(s)). Filter priority can be used to determine the order in which a dispatch unit 212 will be transmitted through two or more filters (e.g., 208 and 210). When a dispatch unit 212 includes criteria that matches the criteria associated with one or more filters, dispatch channel 202 can use, for example, standard method calls to transmit dispatch unit 212 to the respective filters, optionally based on priority. A filter that receives a dispatch unit 212 can read and modify dispatch unit 212, return dispatch unit 212 to server module 204a-n, transmit dispatch unit 212 to another filter, or transmit dispatch unit 212 to client module 206a-n. Client module 206a-n can transmit dispatch 214 to server module 204a-n via the same filters that were used to transmit dispatch unit 212 from server module 204a-n to client module 206a-n.

A context can be used to provide a data-independent mechanism for grouping different dispatch units 212 in system 200. Server module 204a-n, client module 206a-n, or filter(s) 208, 210 can request the creation of a new context, and then various dispatch units 212 can be created as determined by a particular context, as described above.

A dispatch unit 212 can thus belong to a context and, for example, be queried for the owning context. A context can contain any number of dispatch units 212, 214. While a dispatch unit 212, 214 is transient in nature, a context is more persistent and can remain, for example, in memory (e.g., random access memory) of proxy server 104 until the owner (e.g., client 102c) of the context decides that it should be disposed of.

In operation, filters 208, 210 are registered with dispatch channel 202 with criteria and priority information to identify which dispatch units 212, 214 each filter 208, 210 is to receive, and in which order. Dispatch units 212 can be registered, for example, at run time with a standard method call. Dispatch units 212 can also be registered at setup time using standard software configuration techniques. Criteria can include, for example, that a filter (e.g., filter 208) is only interested in receiving outbound messages (messages transmitted from clients 102a-n), inbound messages only (messages transmitted to client 102a-n) and/or messages transmitted in accordance with a certain protocol (e.g., the AIM protocol). Server module 204a-n and client module 206a-n can also be registered with dispatch units 212, 214 to indicate to dispatch units 212, 214 which protocol(s) the server module(s) 204a-n and client module(s) process 206a-n.

Upon receiving a request dispatch unit 212, dispatch channel 202 can identify which filters 208, 210 need to be utilized, and in which order, based on dispatch unit 212 attributes. Dispatch channel 202 can transmit dispatch unit 212 to one or more corresponding filters (e.g., filter 208). Dispatch unit 212 is transmitted to a client module 206a-n, which will transmit a response dispatch unit 214 that will pass through the same filter(s) (e.g., filter 208) that received the request dispatch unit 212, but in the reverse order. Response dispatch unit 214 is transmitted to client 102a-n from which dispatch unit 212 was originated.

Filters 208, 210 can be registered with dispatch channel 202 by, for example, calling a standard registration method on dispatch channel 202 or, for example, by adding an entry in a filter settings (e.g., an Extensible Markup Language (XML) setting) for the dispatch channel.

In addition to a pointer to a filter (or to the module and class name in the case of XML registration), a criteria can be provided to dispatch channel 202. The criteria can specify, for example, which dispatch units a particular filter (e.g., filter 210) will receive, and what the priority for a filer is.

When a dispatch unit 212 is transmitted through dispatch channel 202, dispatch channel 202 can create a filter chain (e.g., filter 208 and two other filters that are not shown) that contains an ordered list of filters that dispatch unit 212 will pass through on its way to client module 206a-n. The filter chain will generally contain all filters whose criteria match the dispatch unit 212 attributes, and be ordered by the priority setting for each respective filter within the filter chain.

During the life of dispatch unit 212, dispatch unit 212 is transmitted twice through the filter chain list, the first time as a request dispatch unit 212, and then as a response dispatch unit 214. Different methods can be called on various filters to indicate whether the dispatch unit being passed is a request dispatch unit 212 or a response dispatch unit 214.

Server module 204a-n and client module 204a-n can be used to ensure that the same dispatch unit 212 object passed as a request is passed back as a response dispatch unit 214. In this manner, filters in a filter chain are able to temporarily store data in request dispatch unit 212, and retrieve it later when dispatch unit 214 is transmitted back as a response.

When a request dispatch unit 212 is passed to a filter (e.g., filter 208), the filter can query and manipulate dispatch unit 212 attributes, in addition to blocking the dispatch unit 212 and transmitting back a response packet via the filter chain to server module 204a-n.

When a dispatch unit 212 is created, the destination client module 206a-n will inform dispatch channel 202 which server module 206a-n to transmit the dispatch unit 214 to.

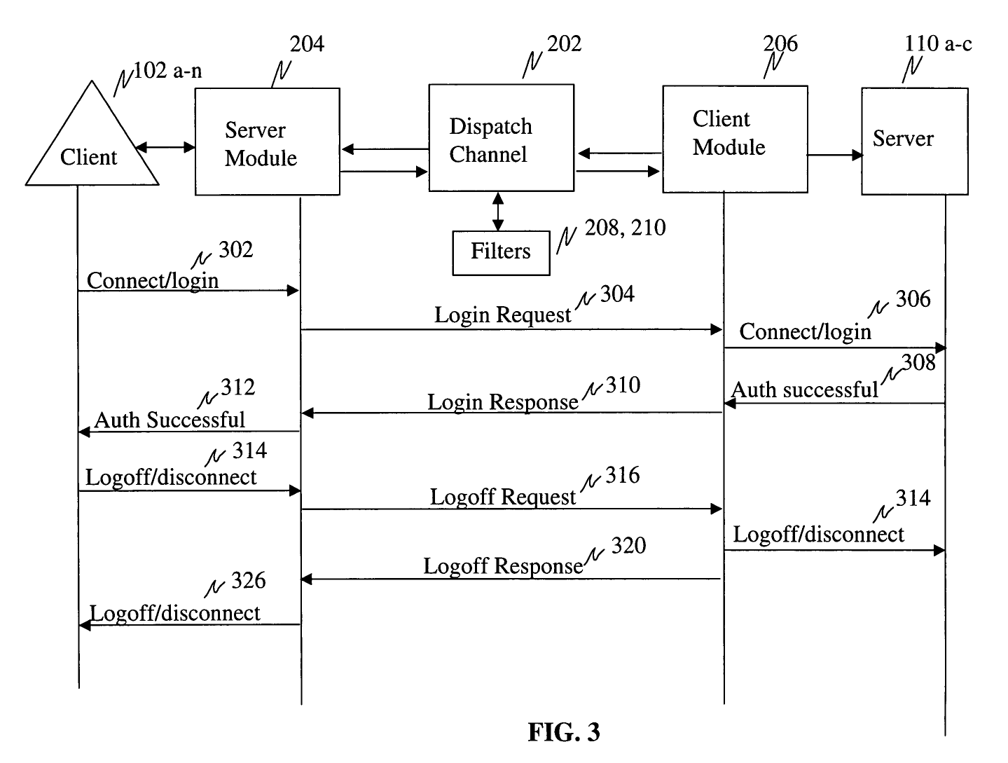

FIG. 3 is a diagram of a process flow in accordance with an embodiment of login and logout operations of the present invention, which also illustrates an overview of a method according to the present invention. For client 102a-n login 302 operations, a login request dispatch unit 304 for a client 102a-n login is generated by server module 204 when client 102a-n attempts to establish a session. Login request dispatch unit 304 will generally pass through one or more filters 208, 210. Client module 206 receives login request dispatch unit 304, and establishes a connection 306 with server 110a-c which, in turn, transmits a message 308 to client module 206 indicating that the login was successful. Client module 206 generates a login response dispatch unit 310, and transmits the response dispatch unit 310 to server module 204 which, in turn, transmits a message 312 indicating that the client 102a-n login to server 110a-c was successful. Response dispatch unit 310 will generally pass through and utilize the same filters 208, 210 as login request dispatch unit 304, but in reverse order. Login request dispatch unit 304 can include events generated by and information published by client 102a-n on behalf of a particular user account and the events generated for and information published to client 102a-n on behalf of a particular user.

Similarly, for client 102a-n logoff/disconnect operations 314, a logoff/disconnect request dispatch unit 316 for a client 102a-n is generated by server module 204 when client 102a-n attempts to logoff 314 of server 110a-c. Logoff request dispatch unit 316 will generally pass through one or more filters 208, 210 to client module 206 which, in turn, transmits logoff/disconnect request 314 to server 110a-c. Client module 206 will also transmit a logoff response dispatch unit 320 to server module 204 when it receives an indication from server 110a-c that the logoff operation was successful. Logoff response dispatch unit 320 will generally pass through and utilize the same filters 208, 210 as logoff request dispatch unit 320, but in reverse order. It should be understood that server 110a-c can also request a logoff operation, in which case operations 314, 316, 320 and 326 will be implemented from the perspective of server 110a-c with respect to client 102a-n.

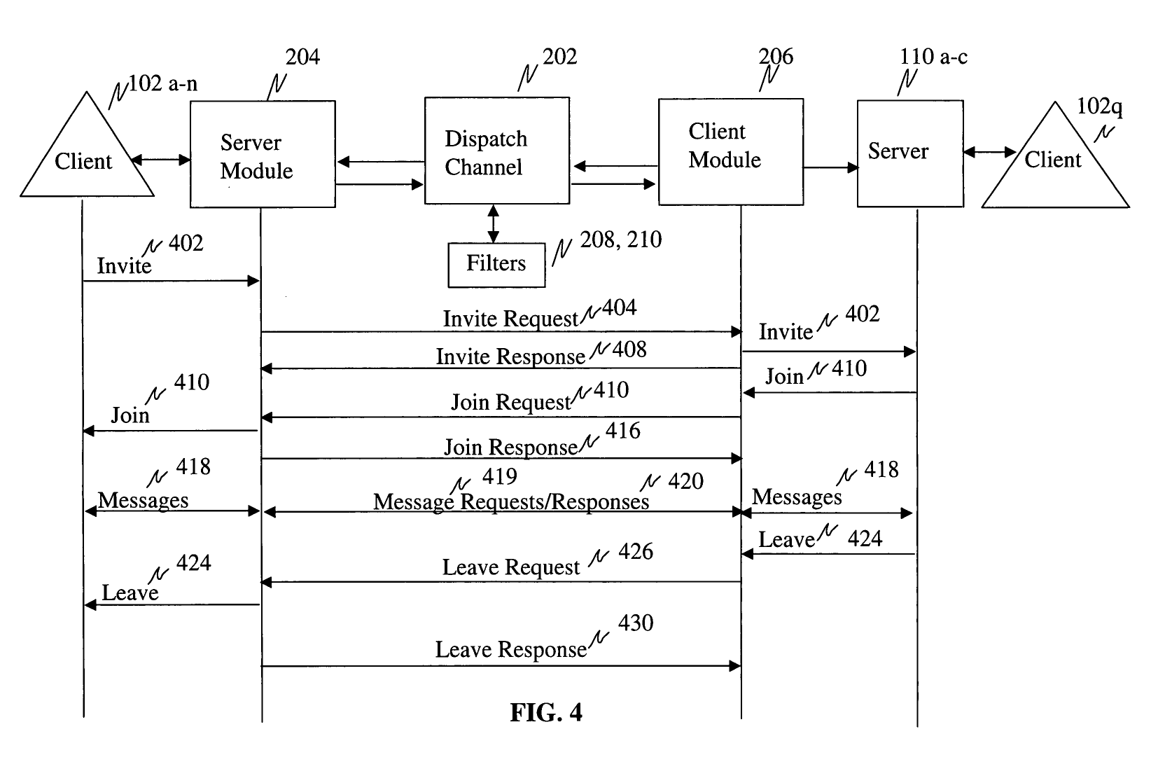

FIG. 4 is a diagram of a process flow in accordance with an embodiment of messaging operations of the present invention, which also illustrates an overview of a method according to the present invention. Messaging operations include invite, join, and leave. In general, if client 102a is participating in an IM session started by client 102q, client 102a can invite others client(s) 102r to join the session just as client 102a would when client 102a starts its own IM session. Invited clients(s) can then join the conversation, and will start to receive messages sent to the conversation and be able to send messages to the conversation. Client 102a can also leave the conversation, and not receive any more messages.

For client 102a-n messaging operations, client 102a issues an invite 402. Server module 204 generates invite request dispatch unit 404, which will generally pass through one or more filters 208, 210. Client module 206 transmits invite 402 to server 110a-c, and also generates an invite response dispatch unit 408, which is transmitted to server module 204 using one or more filters 208, 210. Server 110a-c generates a joint response 410, and client module 206 generates a joint request dispatch unit 410, which is transmitted to server module 204. Server module 204 transmits join response 410 to one of requesting clients 102a-n, and a join response dispatch unit 416 to client module 206. Join response dispatch unit 416 will generally pass through one the same filters 208, 210 as join request dispatch unit 410, but in reverse order.

At this point, client 102a-n can transmit messages 418, for example, to client 102q. When client 102a-n transmits a message 418, server module 204 can generate a message request dispatch unit 419, which is transmitted to client module 206 using one or more filters 208, 210. Message 418 is transmitted by client module 206 to server 110a-c which, in turn, transmits message 418 to client 102q. Client module 206, in turn, generates a message response dispatch unit 420, and transmits message response dispatch 420 unit to server module 204, generally using the same filters as message request dispatch unit 419, but in reverse order. Client 102q can transmit a message 418 to client 102a-n in an analogous manner.

Client 102q can issue a leave request 424, which is received by server 110a-c and transmitted to client module 206. Client module 206 creates a leave request dispatch unit 426, and transmits leave request dispatch unit 426 to server module 204 using one or more filters 208, 210. Server module 204 transmits leave request 424 to client 102a-n, and also transmits a leave response dispatch unit 430 to client module 206, generally using the same filters as leave request dispatch unit 426, but in reverse order.

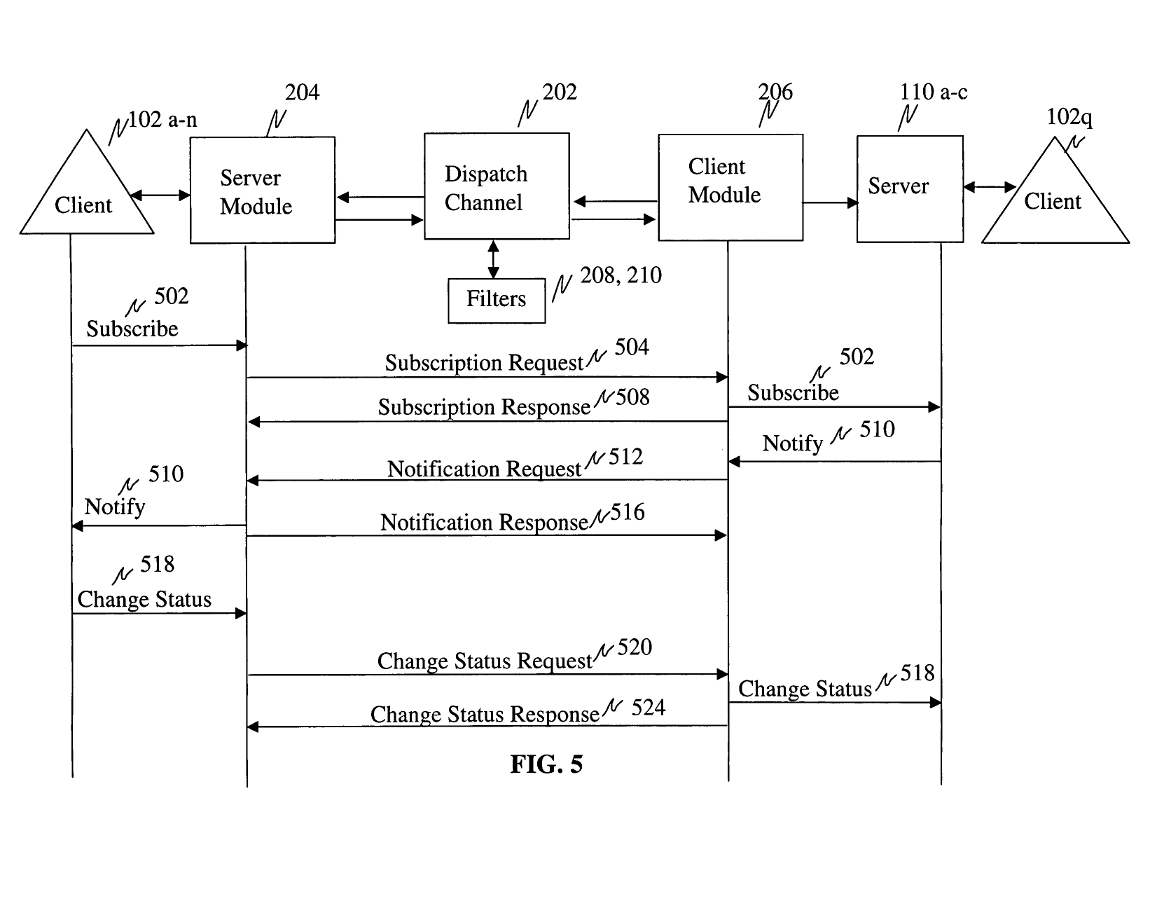

FIG. 5 is a diagram of a process flow in accordance with an embodiment of subscription, notification and status change operations of the present invention, which also illustrates an overview of a method according to the present invention.

A subscription is a request from a client (e.g., client 102a) to receive presence updates from another client (e.g., client 102q). The client 102q receiving the request may refuse a subscription, and thus prevent the requesting client 102a from seeing presence updates. If client 102q accepts the subscription, client 102q will receive an indication that client 102a has subscribed to client 102q. If receiving client 102q approves the subscription, the requesting client 102a will see presence updates. Client 102a can also unsubscribe from or with respect to client 102q, in which case client 102a will not receive notifications of the presence of client 102q.

Notification provides the presence information about a client that another client has subscribed to. For example, if client 102a has subscribed to client 102q, client 102a would receive notifications regarding the presence information for client 102q. If client 102q changes its status from, for example, from “online” to “away,” a message indicating that the status of client 102q has changed can be transmitted to client 102a.

Now suppose that client 102a changes its status. In this case, client 102a can transmit a change status message to proxy server 104 so that other clients (e.g., clients 102p, q) that subscribe to client 102a will know that client 102a has changed its status.

Referring now to FIG. 5, client 102a, for example, can subscribe 502 to another client, such as client 102q. The subscription request 502 is transmitted from client 102a to server module 204, which generates a subscription request dispatch unit 504 that will generally pass through one or more filters 208, 210. Client module 206 establishes a connection with server 110a-c, and transmits the subscription request 502 to server 110a-c. Client module 206 also transmits a subscription response dispatch unit 508 to server module 204 that indicates whether the subscription request 502 was accepted by client 102q. Subscription response dispatch unit 508 will generally pass through the same filters as subscription request dispatch unit 504, but in reverse order.

When client 102q changes its status, client 102q transmits a notify message 510 to server 110a-c which, in turn, transmits notify message 510 to client module 206. Client module 206, in turn, generates a notification request dispatch unit 512, which is transmitted to server module 204 using one or more filters 208, 210. Server module 204 transmits notify message 510 to client 102a, thereby notifying client 102a that client 102q has changed its status. Server module 204 also transmits a notification response dispatch unit 516 to client module 206, indicating that client 102a has been notified of the change in status of client 102q. Notification response dispatch unit 516 will generally use the same filters 208, 210 as notification request dispatch unit, but in reverse order.

Now suppose that client 102a changes its status. In this case, client 102a can transmits a change status message 518 to server module 204. Server module 204 generates a change status request dispatch unit 520, which is transmitted to client module 206 using one or more filters 208, 210. Client module 206 transmits the change status message 518 to server 110a-c which, in turn, transmits the change status message 518 to client 102q. Client module 206 also transmits a change status response dispatch unit 524 to server module 204, indicating to server module 204 that client module 206 has transmitted the change status message 518 to client 102q. Change status response dispatch unit 524 will generally user the same filters 208, 210 as change status request dispatch unit 520, but in reverse order.

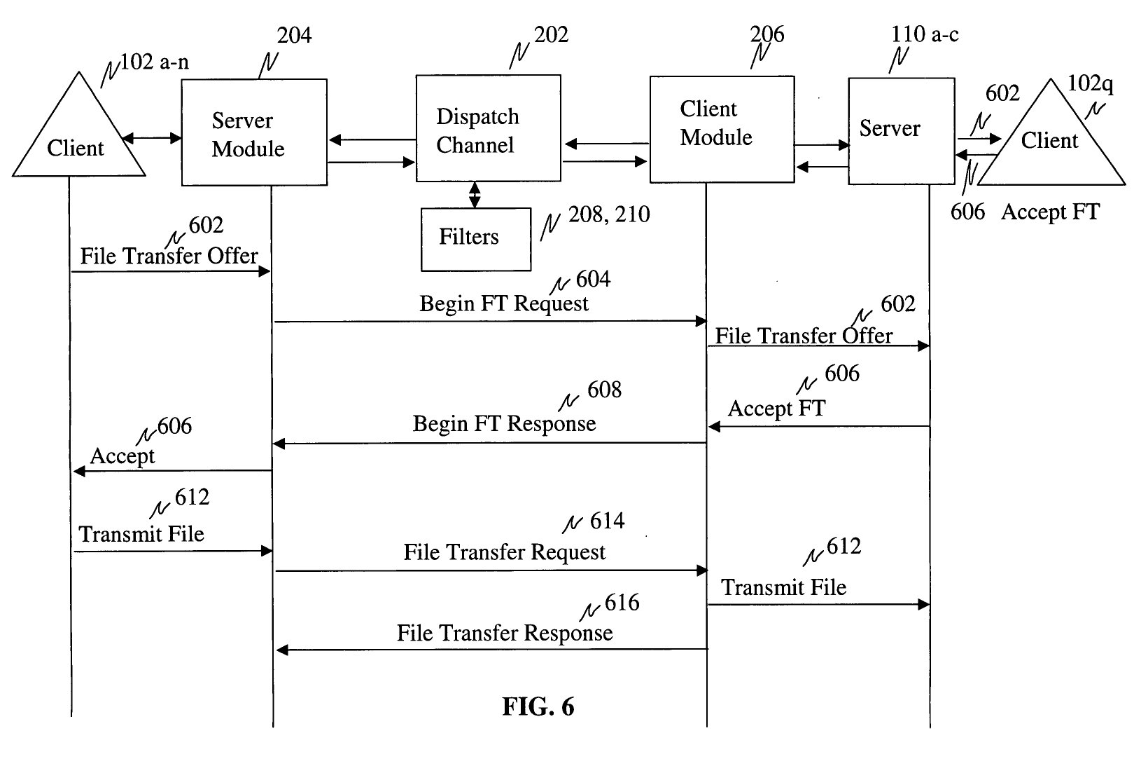

FIG. 6 is a diagram of a process flow in accordance with an embodiment of file transfer operations of the present invention, which also illustrates an overview of a method according to the present invention. Client 102a makes a file transfer offer 602 to another client 102q. Server module 204 receives file transfer offer 602, and transmits a begin file transfer request dispatch unit 604 to client module 206 using dispatch channel 202 and one or more filters 208, 210. Client module 206 transmits file transfer offer 602 to server 110a-c which, in turn, transmits file transfer offer to client 102q. Client 102q transmits an accept file transfer offer 606 to server 110a-c which, in turn, transmits the accept file transfer offer 606 to client module 206. Client module 206 then transmits a begin file transfer response dispatch unit 608 to server module 204 which, in turn, transmits the accept file transfer message 606 to client 102a-n. Begin file transfer response dispatch unit 608 will generally user the same filters as begin file transfer request dispatch unit 604, but in reverse order.

Client 102a-n then transmits file 612 to server module 204 which, in turn, generates a file transfer request dispatch unit 614 and transmits file transfer request dispatch unit 614 to client module 206 using one or more filters 208, 210. Client module 206 then transmits file 612 to server 110a-c which, in turn, transmits file 612 to client 102q. When file 612 has been successfully transmitted to client 102q, client module 206 generates a file transfer response dispatch unit 616 and transmits the file transfer response dispatch unit 616 to server module 204, generally using the same filters 208, 210 as file transfer request dispatch unit 614, but in reverse order.

Client 102a-n and/or client 102q can request that the file transfer be cancelled after file transfer request dispatch unit 704 has been generated and before file transfer response dispatch unit 716 has been generated.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention. While the foregoing invention has been described in detail by way of illustration and example of preferred embodiments, numerous modifications, substitutions, and alterations are possible without departing from the scope of the invention defined in the following claims.

Having thus described our invention, what we claim as new and desire to secure by Letters Patent is as follows:

1. A computer program product residing on a computer readable medium, for use in a computer network environment that utilizes one or more instant messaging (IM) protocols, the computer program product comprising instructions for causing a computer to:
receive a message transmitted by a first client;
deconstruct the message by:
identifying the message by a type of operation;
identifying at least one attribute associated with the message; and
filtering the message based upon the at least one attribute; and
reconstruct the message for transmission to a second client.

2. The computer program product according to claim 1, wherein the message is deconstructed into one or more dispatch units.

3. The computer program product according to claim 2, wherein the filtering instructions can block the one or more dispatch units, redirect the one or more dispatch units, pass the one or more dispatch units, or inject a new dispatch unit.

4. The computer program product according to claim 3, wherein the one or more dispatch units transmitted to the filtering instructions are associated with one or more IM protocols.

5. The computer program product according to claim 4, wherein a data construct used in connection with each of the one or more dispatch units is transparent to the filtering instructions.

6. The computer program product according to claim 1, wherein the deconstruct and reconstruct instructions are transparent to the second client.

7. The computer program product according to claim 1, further comprising instructions that facilitate access to data pertaining to the type of operation.

8. The computer program product according to claim 1, further comprising instructions that facilitate access to data pertaining to the at least one attribute.

9. The computer program product according to claim 1, wherein the type of operation comprises one of a login, a logout, a transmitted message, a received message, a subscription, a notification, a status change, a privacy list, a default privacy setting, and a file transfer.

10. The computer program product according to claim 9, wherein the login operation comprises at least one of a login request and a login response, and the logout operation comprises at least one of a logoff request and a logoff response.

11. The computer program product according to claim 9, wherein the transmitted message operation comprises at least one of an invite request, an invite response, a join request, a join response, a message request, a message response, a leave request, and a leave response.

12. The computer program product according to claim 9, wherein the subscription, the notification, and the status change operations respectively comprise at least one of a request and a response.

13. The computer program product according to claim 9, wherein the privacy list operation comprises at least one of an allow user request and response, a block user request and response, a default privacy setting request and response, and an allow list request and response.

14. The computer program product according to claim 9, wherein the file transfer operation comprises at least one of i) a begin file transfer request and response, ii) a file transfer request and response, iii) a cancel file transfer request and response, iv) a source protocol, v) a destination protocol and vi) a property bag comprising one or more of items i), ii), iii), iv) and v).

15. The computer program product according to claim 1, wherein the attributes comprise at least one of family, type, context, source end point, destination end point, and direction.

16. The computer program product according to claim 1, wherein the one or more IM protocols comprise at least one of AOL Instant Messenger (AIM), Yahoo Messenger, MSN, the Extensible Messaging and Presence Protocol (XMPP), the International Telecommunication Union (ITU) H.323 standard, Yahoo Messenger, and the Session Initiation Protocol (SIP).

17. A method for use in a computer network environment that utilizes one or more instant messaging (IM) protocols, comprising:
receiving a message transmitted by a first client;
deconstructing the message by:
identifying the message by a type of operation and a context;
identifying at least one attribute associated with the message; and
filtering the message based upon the at least one attribute; and
reconstructing the message for transmission to a second client.

18. The method according to claim 17, wherein the context comprises one of a login context, a conversation context, and a file transfer context.

19. The method according to claim 17, wherein the type of operation comprises one of a login, a logout, a transmitted message, a received message, a subscription, a notification, a status change, a privacy list, a default privacy setting, and a file transfer.

20. The method according to claim 19, further comprising facilitating access to data pertaining to the type of operation.
